(19) United States
(12) Patent Application Publication
(10) Pub. No.: US 2016/0306304 A1
(43) Pub. Date: Oct. 20, 2016

(54) FIXING DEVICE AND IMAGE FORMING APPARATUS INCORPORATING SAME

(71) Applicants: Kaori Hemmi, Kanagawa (JP); Masami Okamoto, Kanagawa (JP); Keisuke Kubota, Kanagawa (JP); Yuuki Kikushima, Kanagawa (JP); Shuutaroh Yuasa, Kanagawa (JP); Fumihiro Hirose, Kanagawa (JP); Kensuke Yamaji, Kanagawa (JP); Kenji Nozawa, Kanagawa (JP)

(72) Inventors: Kaori Hemmi, Kanagawa (JP); Masami Okamoto, Kanagawa (JP); Keisuke Kubota, Kanagawa (JP); Yuuki Kikushima, Kanagawa (JP); Shuutaroh Yuasa, Kanagawa (JP); Fumihiro Hirose, Kanagawa (JP); Kensuke Yamaji, Kanagawa (JP); Kenji Nozawa, Kanagawa (JP)

(73) Assignee: Ricoh Company, Ltd., Tokyo (JP)

(21) Appl. No.: 15/097,663

(22) Filed: Apr. 13, 2016

(30) Foreign Application Priority Data
Apr. 17, 2015 (JP) 2015-085071

(51) Int. Cl. G03G 15/20

(52) U.S. Cl. CPC G03G 15/205

(57) ABSTRACT

A fixing device includes a heater, a fixing rotator, a pressure rotator, a slider, and a controller. The fixing rotator is heated by the heater. The pressure rotator presses at least a portion of the fixing rotator and forms a nip between the pressure rotator and the fixing rotator. The fixing rotator fixes an unfixed toner image on a recording material in the nip. The slider slides over a surface of the fixing rotator. The controller causes the slider to perform a first sliding operation for a predetermined time after a predetermined condition is satisfied. The controller causes the slider to perform a second sliding operation for a time equal to or less than the predetermined time at earlier timing than when the predetermined condition is satisfied, in addition to the first sliding operation.

### CROSS-REFERENCE TO RELATED APPLICATION

This patent application is based on and claims priority pursuant to 35 U.S.C. §119(a) to Japanese Patent Application No. 2015-085071, filed on Apr. 17, 2015, in the Japan Patent Office, the entire disclosure of which is hereby incorporated by reference herein.

### BACKGROUND

1. Technical Field

Embodiments of this disclosure relate to a fixing device and an image forming apparatus incorporating the fixing device.

2. Related Art

As image forming apparatuses such as copiers, facsimile machines, and printers, various image forming apparatuses using electrophotography are known. An image forming process of such an electrographic image forming apparatus includes steps of forming an electrostatic latent image on a surface of a photoconductor drum that is an image bearer, developing the electrostatic latent image on the photoconductor drum with a toner that is a developer or the like and making the electrostatic latent image a visible image, transferring the developed image to a recording material (also referred to as recording medium, sheet of paper, or recording sheet) by a transfer device to bear the image, and fixing an unfixed toner image on the recording medium by a fixing device that uses pressure, heat, and the like.

For the fixing device, various systems have been proposed. For example, a belt fixing system is known, which includes a fixing roller disposed opposite to a pressure roller, and an endless fixing belt (fixing rotator) stretched around the fixing roller and a heat roller, and which pressurizes and fixes the unfixed toner image to the recording medium by providing heat of the heat roller to the recording medium through the fixing belt with a nip formed by pressure of the pressure roller and the fixing belt.

In such a fixing device, a surface of the fixing rotator may be damaged with an edge portion of the recording material as the recording material is conveyed to the nip. After a large number of the recording materials are passed, the damaged portion (hereinafter, referred to as damage or surface damage) may become a streak and appear on an image as a gloss streak, resulting in an abnormal image.

In response to that, a polisher is known that slides over and polishes the surface of the fixing rotator to reduce the streak damage and recover a surface state of the fixing rotator.

### SUMMARY

In an aspect of the present disclosure, there is provided a fixing device that includes a heater, a fixing rotator, a pressure rotator, a slider, and a controller. The fixing rotator is heated by the heater. The pressure rotator presses at least a portion of the fixing rotator and forms a nip between the pressure rotator and the fixing rotator. The fixing rotator fixes an unfixed toner image on a recording material in the nip. The slider slides over a surface of the fixing rotator. The controller causes the slider to perform a first sliding operation for a predetermined time after a predetermined condition is satisfied. The controller causes the slider to perform a second sliding operation for a time equal to or less than the predetermined time at earlier timing than when the predetermined condition is satisfied, in addition to the first sliding operation.

In another aspect of the present disclosure, there is provided an image forming apparatus that includes the fixing device.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a schematic view of a configuration of an image forming apparatus according to an embodiment of the present disclosure;

FIG. 2 is a schematic view of a configuration of a fixing device according to an embodiment of the present disclosure;

FIG. 3 is a graph illustrating a relationship between the number of passed sheets and belt surface roughness of when recording materials of a plain paper, a plain paper (unfavorable paper), and special paper are passed according to an embodiment;

FIG. 4 is a graph illustrating a relationship between the number of passed sheets and belt surface roughness of when fixing speeds are different according to an embodiment;

FIG. 5 is an illustration of a sliding operation by a fixing device according to the present embodiment, and is a graph illustrating a relationship between the cumulative number of passed sheets and belt surface roughness;

FIG. 6 is a schematic view of a configuration (1) of a fixing device according to another example of an embodiment; and

FIG. 7 is a schematic view of a configuration (2) of a fixing device according to another example of an embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

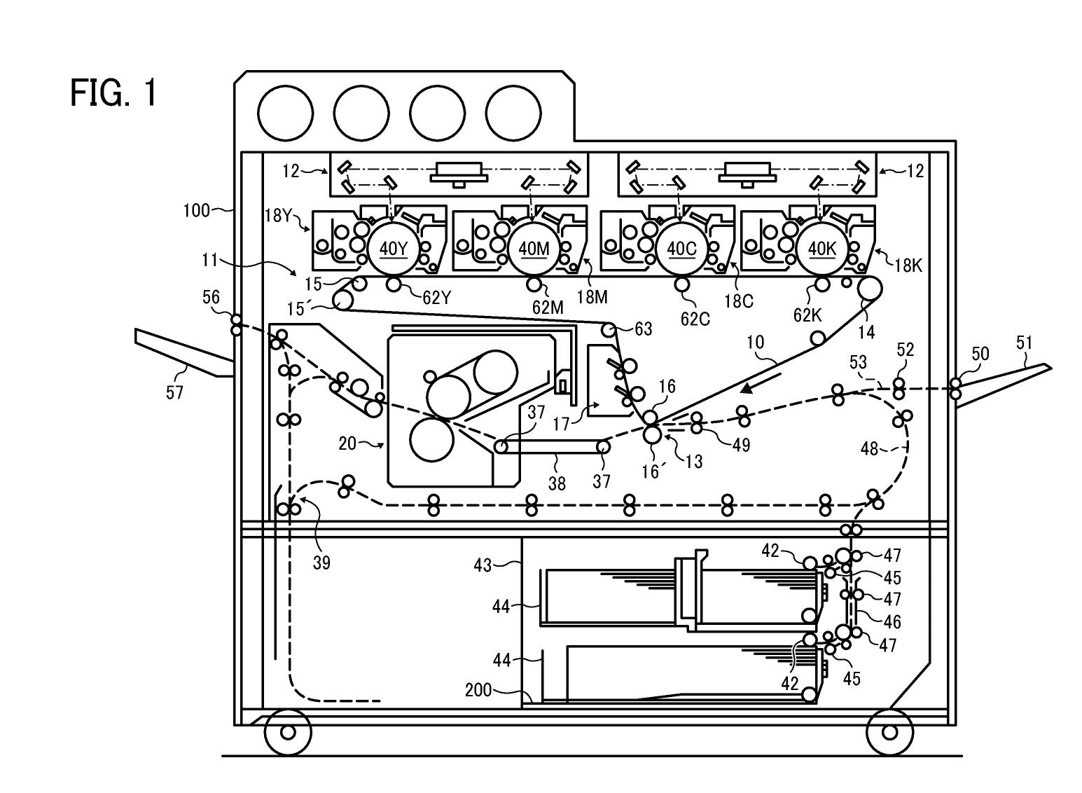

Hereinafter, a configuration according to an embodiment of the present disclosure will be described with reference to FIGS. 1 to 7.

### (Image Forming Apparatus)

An image forming apparatus according to an embodiment of the present disclosure will be described with reference to FIG. 1. Examples of the image forming apparatus include an embodiment that performs image formation using a toner, such as a printer, a copier, and a facsimile machine. The image forming apparatus includes a fixing device that fixes a toner image (unfixed image) formed on a sheet that is a recording medium.

FIG. 1 is a schematic view of a configuration of an image forming apparatus body 100 of the present embodiment. The image forming apparatus body 100 of the present embodiment is a tandem-type intermediate transfer system, and includes a sheet feed table 200 having sheet feed trays 44 in a lower portion.

Further, a tandem-type image forming section 11 of the tandem-type intermediate transfer system, in which a plurality of image forming units 18Y, 18M, 18C, and 18K is disposed side by side, is provided inside the image forming apparatus body 100. Letters of Y, M, C, and K attached to the reference codes respectively represent colors of yellow, magenta, cyan, and black.

In the image forming apparatus body 100, an endless belt type intermediate transfer body (hereinafter, intermediate transfer belt) 10 is provided near the center. This intermediate transfer belt 10 is looped around and supported by a plurality of rollers 14, 15, 15′, and 16, and the like, and is rotatable and conveyable in a clockwise manner in FIG. 1.

In the configuration example of FIG. 1, a cleaning device 17 for intermediate transfer belt is provided at a downstream side of the secondary-transfer opposing roller 16 that is one of the aforementioned support rollers in a direction of rotation of the intermediate transfer belt 10. The cleaning device 17 removes a residual toner remaining on the intermediate transfer belt 10 after transfer of an image.

The four image forming units 18Y, 18M, 18C, and 18K of yellow (Y), magenta (M), cyan (C), and black (K) are disposed above the intermediate transfer belt 10 stretched over the support roller 14 and the support roller 15 along the conveyance direction. The reference codes are abbreviated to 18 (Y, M, C, and K).

In this way, the four image forming units 18 (Y, M, C, and K) are disposed side by side, and configure the tandem-type image forming section 11, as described above. The image forming units 18 (Y, M, C, and K) of the tandem-type image forming section 11 respectively include photoconductor drums 40 (Y, M, C, and K) as image bearers that bear toner images of the respective colors of yellow, magenta, cyan, and black.

Then, two exposure devices 12 are provided above the tandem-type image forming section 11, as illustrated in FIG. 1. The exposure devices 12 are respectively provided corresponding to two image forming units (18Y and 18M, and 18C and 18K). The exposure devices 12 are exposure devices in an optical scanning system, which are configured from a light source device such as a semiconductor laser, a semiconductor laser array, or a multibeam light source, a coupling optical system, a common optical deflector with a polygon mirror and the like, two scanning imaging optical systems, and the like. The exposure devices 12 perform exposure to the photoconductor drums 40 (Y, M, C, and K) according to image information of the respective colors of yellow, magenta, cyan, and black, and forms electrostatic latent images.

Further, following members are provided around the photoconductor drums 40 (Y, M, C, and K) and the image forming units 18 (Y, M, C, and K). The members include a charging device that uniformly charges the photoconductor drums prior to the exposure, a developing device that develops the electrostatic latent images formed by the exposure with the toners of the respective colors, and a photoconductor cleaning device that removes post-transfer residual toners on the photoconductor drums.

Further, primary transfer rollers 62 (Y, M, C, and K) are provided in a primary transfer position where the toner images are transferred from the photoconductor drums 40 (Y, M, C, and K) to the intermediate transfer belt 10. The primary transfer rollers 62 (Y, M, C, and K) are provided to oppose the photoconductor drums 40 (Y, M, C, and K) across the intermediate transfer belt 10, and serve as components of a primary transfer device.

The support roller 14, of the plurality of support rollers that supports the intermediate transfer belt 10, is a drive roller that drives and rotates the intermediate transfer belt 10, and is connected with a motor through a drive transmission device (not illustrated) including a rear, a pulley, a belt, and the like. Further, in a case of forming a black monochromatic image on the intermediate transfer belt 10, the photoconductor drums 40 (Y, M, and C) can be separated from the intermediate transfer belt 10 by moving the support rollers 15 and 15′ other than the support roller 14 with a moving assembly (not illustrated). In addition, a back-up roller 63 is also provided as a support roller.

A secondary transfer device 13 is provided at a side opposite to the tandem-type image forming section 11 across the intermediate transfer belt 10. This secondary transfer device 13 transfers the image on the intermediate transfer belt 10 to a sheet as a sheet-like recording medium by pressing the secondary transfer roller 16′ against the secondary-transfer opposing roller 16 and applying a transfer electric field, in the example of FIG. 1.

Further, a fixing device 20 that fixes the transferred image on the sheet is provided beside the secondary transfer device 13. The sheet on which the image is transferred in the secondary transfer device 13 is conveyed to the fixing device 20 with a conveyance belt 38 supported by two rollers 37. Apparently, the conveyance belt 38 may be a secured guide, or may be a conveyance roller or the like.

Further, in the example of FIG. 1, a sheet reverse device 39 that reverses the sheet and conveys the sheet to record images on both surfaces of the sheet is provided in a lower portion of the secondary transfer device 13 and the fixing device 20 in parallel to the above-described tandem-type image forming section 11.

Further, conveyance of sheets is performed as follows. First, one of sheet feed rollers 42 of the sheet feed table 200 is selectively rotated, and the sheets are sent out from one of the sheet feed trays 44 provided in multistage in a paper bank 43. The sent-out sheets are separated by a separation roller 45 one by one. The sheet is introduced into a sheet feed path 46, conveyed by paired conveyance rollers 47, introduced into a sheet feed path 48 in the image forming apparatus body 100, and then abuts against and is stopped by paired positioning rollers (registration rollers) 49.

Further, in a case of using a sheet feeding tray 51, a sheet feed roller 50 is rotated, and the sheets on the sheet feeding tray 51 are sent out and separated by a separation roller 52 one by one. Then, the sheet is introduced into a manual sheet feed path 53, and similarly abuts against and is stopped by the paired positioning rollers 49.

Following that, the paired positioning rollers 49 are rotated in accordance with formation of a full color toner image on the intermediate transfer belt 10, and the sheet is sent to a secondary transfer position between the intermediate transfer belt 10 and the secondary transfer roller 16′. Then, the full color toner image on the intermediate transfer belt 10 is collectively transferred on the sheet.

The sheet on which the toner image has been transferred is conveyed and sent to the fixing device 20 with the conveyance belt 38, and heat and pressure are applied to the sheet by the fixing device 20, and the transferred toner image is fixed, and then the sheet is discharged onto a sheet ejection tray 57 by an ejection roller 56 and stacked.

In the case of duplex copying, a sheet with one surface on which an image has been fixed is introduced into the sheet reverse device 39 and reversed, and then introduced into the secondary transfer position again. An image is transferred on a back surface and fixed by the fixing device 20, and the sheet is then discharged onto the sheet ejection tray 57 by the ejection roller 56.

### (Fixing Device)

The fixing device according to the present embodiment is a fixing device (fixing device 20) that includes a fixing rotator (fixing belt 24) that is heated by a heater (a heater 25 of a heat roller 21), and a pressure rotator (pressure roller 23) disposed capable of pressing at least a part of the fixing rotator and which forms a nip between the pressure rotator and the fixing rotator, and which conveys a recording material (recording medium P) that bears an unfixed toner image (unfixed toner image T) to the nip, and fixes the unfixed toner image to the recording material. The fixing device further includes a slider (slider 30) that slides over a surface of the fixing rotator, and a controller (controller 35) that executes a first sliding operation by the slider throughout a predetermined time after a predetermined condition is satisfied. The controller executes a second sliding operation (additional sliding operation) throughout a time of the predetermined time or less at earlier timing than a time when the predetermined condition is satisfied, in addition to the first sliding operation (normal sliding operation). Note that the bracketed content indicates reference codes and application examples in an embodiment.

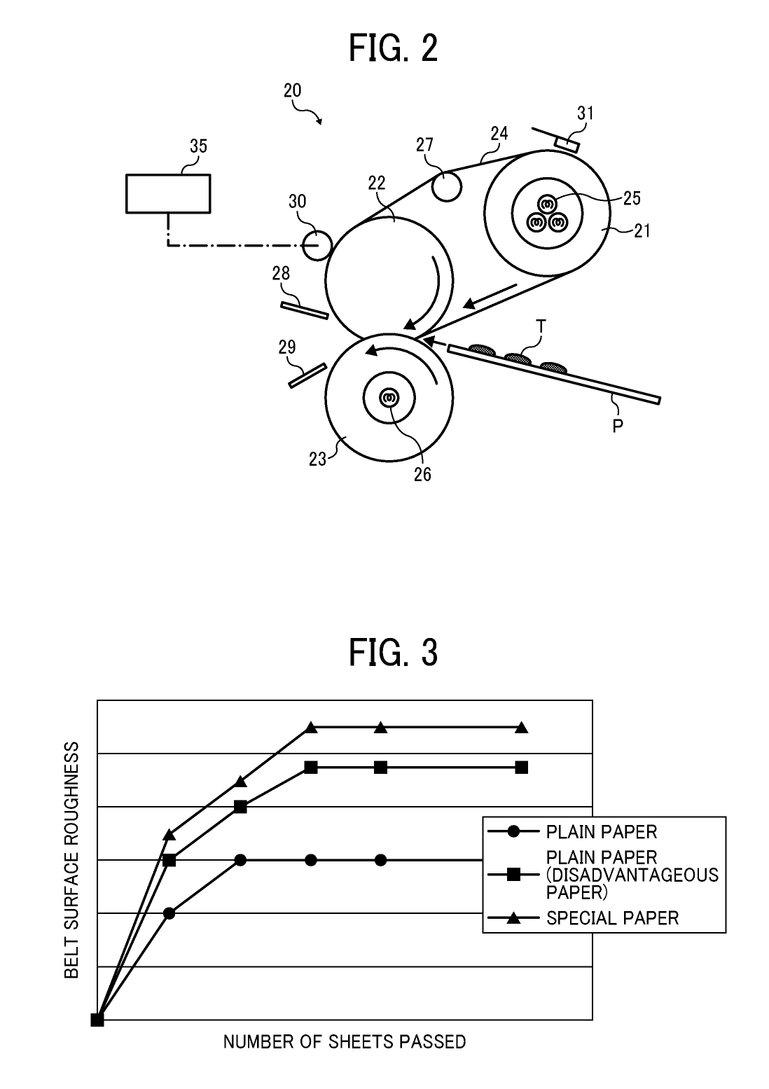

FIG. 2 illustrates an example of the fixing device 20, and is a schematic cross-sectional view of a fixing roller 22 in an axial direction.

The fixing device 20 includes the heat roller 21, the fixing roller 22, the fixing belt 24 stretched around the heat roller 21, the fixing roller 22, and a tension roller 27, the pressure roller 23 that presses the fixing roller 22 to form a nip between the pressure roller 23 and the fixing roller 22, and the like. Further, the heat roller 21 includes the heater 25 as a heat source therein, and the pressure roller 23 includes a heater 26 as a heat source therein.

The fixing device 20 passes the recording medium P, which bears the unfixed toner image T, to the nip of the fixing belt 24 and the pressure roller 23, the nip being formed by pressure of the fixing roller 22 and the pressure roller 23, and heats and fixes the unfixed toner image T. Note that the heat roller 21, the fixing roller 22, and the pressure roller 23 are rotatably supported in a longitudinal direction of a housing of the fixing device 20, and drivers and the like of the rollers are secured and held in the housing.

A leading end portion of the recording medium P that has passed the nip is separated by a separation plate 28 disposed at the fixing roller 22 side or a separation plate 29 disposed at the pressure roller 23 side, and the recording medium P is discharged to the next process. Note that the separation plates 28 and 29 as separators respectively disposed at the fixing roller 22 side and the pressure roller 23 side are not limited to plate members, and separation claws may be used.

The heat roller 21 is a thin cylinder made of a metal material, for example, and the heater 25 as a heat source is fixedly installed inside the cylinder. As the heater 25, a halogen heater or a carbon heater can be used, for example. Further, both lateral ends of the heater are secured to the housing of the fixing device 20. Further, the heater 25 may be an induction heater (IH heater) that heats the heat roller 21 from an outside.

An output of the heater 25 is controlled by power source (alternating-current power source) of the apparatus body, and the heat roller 21 is heated with radiation heat from the heater 25. Further, heat is applied to the unfixed toner image T on the recording medium P from a surface of the fixing belt 24 heated by the heat roller 21. The output control of the heater 25 is made based on a detection result of a belt surface temperature by a temperature sensor 31 such as a thermopile installed in a position opposing the surface of the fixing belt 24. The location and the installation number of the temperature sensors are not limited thereto, and a temperature sensor that detects the temperature of the pressure roller 23, a temperature sensor that detects the temperature of the fixing roller 22, and the like may be provided, and the heaters 25 and 26 may be controlled based on the provided sensors.

The fixing belt 24 is looped around the fixing roller 22 and the heat roller 21, and is closely attached to the heat roller 21 and the fixing roller 22. A fixing nip is configured such that the pressure roller 23 is pressed against a place of the fixing belt 24 configured as described above, the place corresponding to the fixing roller 22.

The fixing belt 24 is an endless belt having a multilayer structure in which an elastic layer of silicone rubber and a release layer are sequentially layered on a base layer made of a polyimide (PI) resin and having a layer thickness of 90 μm.

The elastic layer of the fixing belt 24 has a layer thickness of about 200 μm, and is formed of an elastic material of silicone rubber, fluororubber, or expandable silicone rubber. The release layer of the fixing belt 24 has a layer thickness of about 20 μm, and is formed of a tetrafluoroethylene perfluoroalkyl vinyl ether copolymer resin (PFA), polyimide, polyetherimide, polyether sulfide (PES), or the like. By providing the release layer to the surface layer of the fixing belt 24, releasability (detachability) from the toner (toner image) is secured.

Further, the fixing belt 24 is configured from a PI belt that is an endless film made of a heat resistant resin with a thickness of 90 μm, and the surface layer is coated with an anti-offset agent of a tetrafluoroethylene perfluoroalkyl vinyl ether copolymer resin (PFA) or the like.

The fixing roller 22 does not include a heat source, and is formed such that a core (metal core) of metal (iron or aluminum) having high rigidity is covered with a thick elastic layer of silicone rubber.

The pressure roller 23 is a roller in which an elastic layer of fluororubber, silicone rubber, or expandable silicone rubber is formed on a metal core of Steel Use Stainless (SUS) 304 or the like, similarly to the fixing roller 22. Further, the heater 26 as a heat source is fixedly installed inside the cylinder. Note that the pressure roller 23 may have a configuration without including the heater 26.

The fixing roller 22 and the pressure roller 23 are rubber rollers disposed to oppose each other. The pressure roller 23 is pressurized in a central direction of the fixing roller 22 through the fixing belt 24, so that the nip is formed between the pressure roller 23 and the fixing belt 24.

Further, the controller 35 is a controller that executes various types of control of the fixing device 20. The controller 35 controls a driver that drives the fixing roller 22 to drive and rotate the fixing roller 22 in a clockwise direction. With the rotation of the fixing roller 22, the pressure roller 23 pressed against the fixing roller 22 and the fixing belt 24 are rotated at the same speed.

Further, the slider 30 pressed against the fixing belt 24 with a predetermined pressure and rotated in conjunction with the rotation of the fixing belt 24 is included on an outer circumferential surface of the fixing belt 24.

The slider 30 slides over and polishes the surface of the fixing belt 24 by being biased to the fixing belt 24, recovers surface properties of the fixing belt 24, and make the surface of the fixing belt 24 a surface state suitable for fixing. For example, the slider 30 is a metal core with a surface layer having predetermined roughness, and the surface layer has an uneven shape in the order of several 10 μm. The surface roughness is larger than the surface roughness of the fixing belt 24.

It is favorable that the slider 30 can improve the surface state of the fixing belt 24 throughout the entire region in a direction (axial direction) perpendicular to the conveyance direction of the surface of the fixing belt 24. At this time, the slider 30 may be provided on the entire region in the axial direction. Alternatively, a driver movable in the axial direction may be provided in the slider 30 having a predetermined length, and the driver is made movable to a desired position in the axial direction, so that the surface state may be improved throughout the entire region in the axial direction. Note that the driver may be provided to improve the surface state of about a passage area of at least an edge portion according to the width of the recording medium P to be passed.

The slider 30 includes a driver controlled by the controller 35, and is driven and rotated with a predetermined linear velocity gap from the fixing belt 24 in a forward direction or a reverse direction to the direction of rotation of the fixing belt 24. Further, the slider 30 is favorably separable from the fixing belt 24.

The tension roller 27 has a role to provide certain tension to the fixing belt 24 stretched around two roller members, and is formed of a cylindrical aluminum tube, for example. Note that, in the example of FIG. 2, the tension roller 27 is provided at an inner circumferential side of the fixing belt 24. However, the tension roller 27 may be provided at an outer circumferential side of the fixing belt 24.

Note that it is also favorable to provide a cleaner that removes a residual toner remaining on the surface of the fixing belt 24 around the fixing belt 24. Further, the fixing device 20 illustrated in FIG. 2 is an example of a fixing device that can execute sliding control described below, and the configuration of the fixing device 20 is not limited to the example.

### (Sliding Control)

Next, slide control by the fixing device 20 according to the present embodiment will be described. This sliding control is executed by the controller 35 (controller) of the fixing device 20. The controller is made of a microcomputer that includes a central processing unit (CPU), a read-only memory (ROM), a random access memory (RAM), an input-output (I/O) interface, and the like. Note that, in the present embodiment, the controller 35 has a configuration provided in the fixing device 20. However, the configuration is not limited to the embodiment, and the controller 35 may have a configuration provided in the image forming apparatus body 100.

Types of edge unfavorable papers include a plain paper with severe burr height (referred to as plain paper (unfavorable paper)) and a special paper such as a transparent medium having high hardness.

FIG. 3 is a graph illustrating a relationship between the number of passed sheets and the surface roughness (belt surface roughness) of the fixing belt 24 of when the recording materials of the plain paper, the plain paper (unfavorable paper), and the special paper are passed.

As illustrated in FIG. 3, the type of the recording material and the belt surface roughness has correlation, and a transition of the belt surface roughness is changed every time the number of passed sheets is increased with the passed recording material. As illustrated in FIG. 3, it can be said that the belt surface is more easily damaged in the order of the special paper, the plain paper (unfavorable paper), and the plain paper.

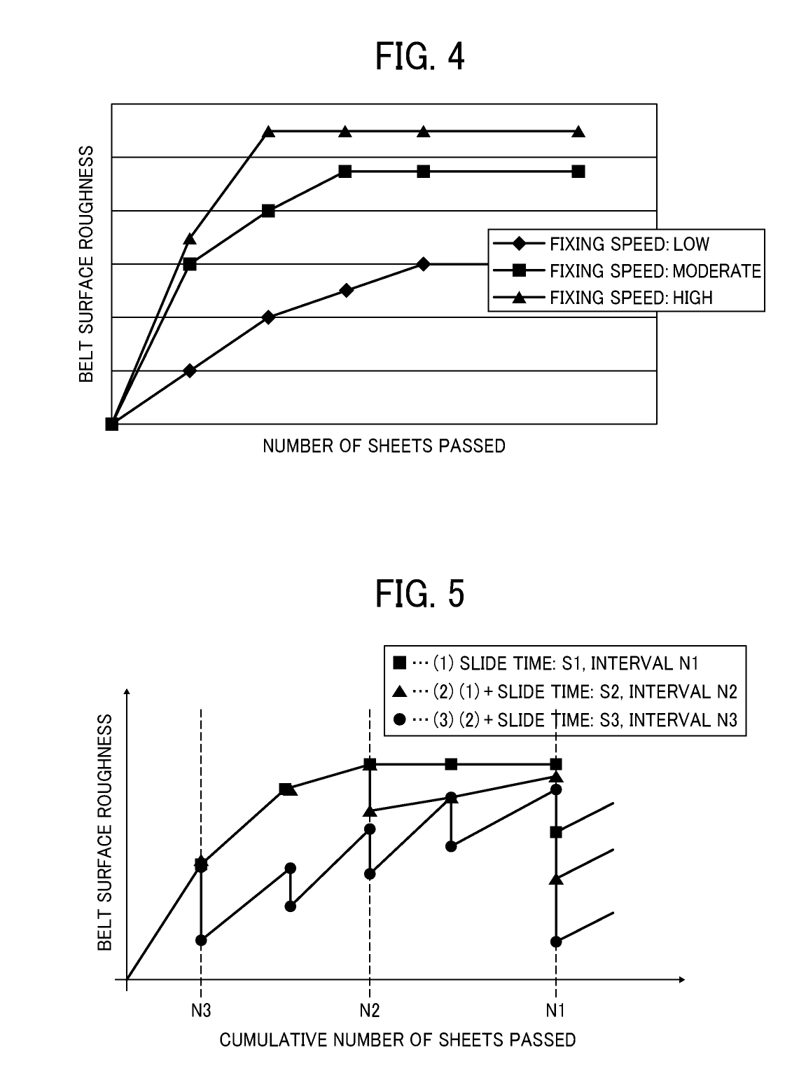

FIG. 4 is a graph illustrating a relationship between the number of passed sheets and the belt surface roughness in a case where fixing speeds (linear velocities) are different.

As illustrated in FIG. 4, the fixing speed and the belt surface roughness has correlation, and when a certain number of sheets is passed with a device having a fast fixing speed, the belt surface roughness becomes coarse at an early stage.

Then, even if the sliding operation by the slider 30 is performed after the surface roughness becomes extremely coarse, polishing is insufficient in a short operation time and the surface state of the fixing belt 24 cannot be sufficiently recovered, and a gloss streak on an image may remain. Further, taking the sliding operation of one time long is led to an increase in an unnecessary sliding operation, and thus this is not favorable.

Therefore, in the fixing device 20 according to the present embodiment, the sliding operation is performed in a short time before the surface of the fixing belt 24 becomes unrecoverable roughness, so that occurrence of an abnormal image is prevented.

In the fixing device 20, normally, the sliding operation (normal sliding operation (first sliding operation)) is performed by the slider 30 throughout a predetermined time (sliding operation time S1) in every predetermined number of passed sheets (the number of passed sheets is N1). In the fixing device 20 according to the present embodiment, in addition to the aforementioned sliding operation, a sliding operation (additional sliding operation (second sliding operation)) is performed in a predetermined time (sliding operation time S2) that is the sliding operation time S1 or less in every number of passed sheets (the number of passed sheets is N2) that is smaller than the number of passed sheets N1.

FIG. 5 is an illustration of the sliding operation by the fixing device 20 according to the present embodiment, and is a graph illustrating a relationship between the cumulative number of passed sheets and the belt surface roughness.

In FIG. 5, (1) indicated by solid square ▪ illustrates a case of executing the normal sliding operation in the sliding operation time S1 in every number of passed sheets N1. Further, (2) indicated by solid triangle ▴ illustrates a case of executing the additional sliding operation in the sliding operation time S2 (S2≦S1) in every number of passed sheets N2 (N2<N1), in addition to the normal sliding operation (1). Further, (3) indicated by solid circle illustrates a case of executing the additional sliding operation in a sliding operation time S3 (S3≦S1) in every number of passed sheets N3 (N3<N2<N1), in addition to the normal sliding operation (1). Note that both of the additional sliding operations (2) and (3) may be performed in addition to the normal sliding operation (1).

As illustrated in FIG. 5, in the cases (2) and (3) where the sliding operations are performed in the shorter sliding times, the belt surface roughness becomes more favorable than the case (1) when the number of passed sheets reaches N1. Therefore, the cases (2) and (3) can more favorably recover the surface state after execution of the normal sliding operation in the sliding operation time S1 with the number of passed sheets N1.

As described above, by executing the additional sliding operation in a time of the normal sliding operation or less at a shorter interval than the normal sliding operation, in addition to executing the normal sliding operation throughout a predetermined sliding operation time in every predetermined number of passed sheets set in advance, the surface state can be prevented from being an unrecoverable state.

### <First Control Example>

Next, a first control example of the fixing device 20 according to the present embodiment will be described. Here, the position of the edge portion is different in each size (sheet width) of the recording material. Therefore, it is favorable that the cumulative number of passed sheets (hereinafter, referred to as the cumulative number of sheets) is counted for each sheet width of the recording material, and the sliding operation is performed when a counter is greater than a certain threshold.

Table 1 is examples of the counter of the cumulative number of sheets of each sheet width section. Here, five sheet width sections are provided. Cases 1 to 5 indicate values of the counter of certain points of time.

TABLE 1

| | Sheet | Sheet | Sheet | | |
|---|---|---|---|---|---|
| | width | width | width | | |
| | section 1 | section 2 | section 3 | Sheet width | Sheet width |
| | Cumula- | Cumula- | Cumula- | section 4 | section 5 |
| | tive | tive | tive | Cumulative | Cumulative |
| | number of | number of | number of | number of | number of |
| | sheets (P) | sheets (P) | sheets (P) | sheets (P) | sheets (P) |
| Case 1 | 1000 | 2000 | 3000 | 4300 | 2000 |
| Case 2 | 1200 | 3000 | 3500 | 2000 | 100 |
| Case 3 | 1200 | 5000 | 3000 | 1000 | 4500 |
| Case 4 | 1200 | 11000 | 3000 | 1000 | 3000 |
| Case 5 | 1200 | 3000 | 12000 | 1000 | 4500 |

Further, Table 2 illustrates examples of a threshold (L) of the number of passed sheets to start the sliding operation, and the sliding operation time. That is, Table 2 illustrates that the sliding operation in S1 time is performed in every cumulative number of sheets that is 10000 sheets (threshold L1), and the sliding operation in S2 time (S2≦S1) is performed in every cumulative number of sheets that is 4000 sheets (threshold L2).

TABLE 2

| | |
|---|---|
| Sliding operation start threshold 1 (=L1) | 10000 |
| Sliding operation time 1 (sec) | S1 |
| Sliding operation start threshold 2 (=L2) | 4000 |
| Sliding operation time 2 (sec) | S2 |

In Case 1, the sheet width section 4 exceeds the threshold L2. That is, the sliding operation in S2 time is performed once.

Note that, as for an execution timing of the sliding operation, it is favorable to execute the sliding operation at predetermined timing after the value of the counter exceeds the threshold L1 or L2. As the predetermined timing, timing after sheet passage of a job (between jobs) is favorable. If the next job is not sent immediately after the sheet passage, a decrease in productivity due to coming-in of the sliding operation can be reduced.

In Case 2, any sheet width section does not exceed the thresholds L1 and L2, and thus the sliding operation has not yet been performed.

In Case 3, the sheet width sections 2 and 5 exceed the threshold L2. Therefore, the sliding operation in S2 time is performed in each timing when the cumulative number of sheets in each of the sheet width sections exceeds the threshold L2 (twice in total).

In Case 4, the sheet width section 2 exceeds the thresholds L1 and L2. In this case, the sliding operation in S2 time is performed twice, and the sliding operation in S1 time is performed once.

In Case 5, the sheet width section 3 exceeds the thresholds L1 and L2, and the sheet width section 5 exceeds the threshold L2. In this case, the sliding operation in S2 time is performed three times, and the sliding operation in S1 time is performed once.

When the cumulative number of sheets is counted in every sheet width, and the slider is made movable in the axial direction, the slider 30 is appropriately moved in the axial direction, and the sliding operation may just be performed for at least a peripheral position of the edge portion of an appropriate sheet width section.

Further, the sliding times S1 and S2 in the respective sliding operations are stored in the controller 35, and it is favorable that the values thereof can be arbitrarily set or changed by a user.

For example, in a case where an abnormal image with a gloss streak due to surface damage cannot be sufficiently resolved in the sliding time set in advance, the setting of the sliding time is changed to be longer by the user, so that an optimum polishing time can be set. Meanwhile, in a case of mainly using a recording material that is less likely to have the surface damage, the setting of the sliding time is changed to be shorter, so that the life of the slider 30 and the fixing belt 24 can be elongated.

### <Second Control Example>

Next, a second control example of the fixing device 20 according to the present embodiment will be described. As already stated, the surface damage of the fixing belt 24 caused by the edge portion of the recording material is substantially affected by the burr height of the recording material.

Therefore, it is favorable to execute the sliding operation in addition to the sheet passage width described in the first control example, or in consideration of a type of the recording material instead.

In the second control example, a more favorable sliding operation is performed by performing weighting according to the amount of burr when the number of passed sheets is accumulated. That is, the weight is increased when a sheet having a high burr is passed. For example, the number of sheet passage count is made n times for the sheet having a high burr, so that the sliding operation comes in a shorter time. In contrast, the weight is decreased when a sheet having a low burr height, for example, the sheet passage count is made 1/n times, so that the sliding operation interval is made long and an unnecessary sliding operation is decreased, and the life of the slider 30 and the fixing belt 24 may be elongated.

Table 3 illustrates count examples of a case where a sheet edge rate (%) that is a weighting coefficient indicating the burr height is set for each recording material, and the sheet edge rate is reflected on the count of the cumulative number of sheets. Note that, in the second control example, the sheet width section is provided, and the number of sheets is counted for each sheet width. However, the sheet width section may not be provided.

TABLE 3

| | | | Sheet | Sheet | Sheet |
|---|---|---|---|---|---|
| | | | width | width | width |
| | | | section 1 | section 2 | section 3 |
| Job information | | | Cumula- | Cumula- | Cumula- |
| | Sheet | Sheet | tive | tive | tive |
| The number of | edge | width | number of | number of | number of |
| job sheets (P) | rate (%) | section | sheets | sheets | sheets |
| 150 | 150 | 2 | — | 225 | — |
| 1500 | 200 | 1 | 3000 | — | — |
| 50 | 150 | 1 | 75 | — | — |
| 2000 | 150 | 2 | — | 3000 | — |
| 300 | 100 | 3 | — | — | 300 |
| Total | | | 3075 | 3225 | 300 |

Here, a count result of the cumulative number of sheets is calculated according to the following formula (1).

The cumulative number of sheets=an actual number of passed sheets (the number of job sheet)×the sheet edge rate (%) (1)

For example, the job information in the first row in Table 3 is a case where 150 sheets of a certain sheet brand with the sheet edge rate of 150% are passed with the sheet width section 2. In this case, from the above formula (1), the cumulative number of sheets is 225 sheets by weighting actual 150 passed sheets by 1.5 (150%). Therefore, the cumulative number of sheets in the sheet width section 2 is 225 sheets.

Similarly, in the job information in the second row, actual 1500 passed sheets are weighted by 2 (200%), and the cumulative number of sheets is calculated as 3000. Further, in the job information in the fifth row, in the case of the sheet edge rate 100(%), no weighting is made, and the cumulative number of sheets is calculated as 300. Execution of the sliding operation according to the cumulative number of sheets is similarly performed to the first control example.

As described above, the weighting taking the burr height into account is conducted according to characteristics of a type (brand) of the recording material, whereby the sliding operation taking the damage of the fixing belt 24 into account can be more favorably performed.

Note that the sheet edge rate of each type (brand) of the recording material is stored in the controller 35, and it is favorable that the value thereof can be added or changed by the user. Accordingly, a new recording material can be supported.

According to the above-described fixing device of the present embodiment, the additional sliding operation is performed in a time of the normal sliding operation or less at a shorter interval than the normal sliding operation, in addition to execution of the sliding operation by the fixing rotator at appropriate timing and in an appropriate execution time, to be specific, execution of the normal sliding operation throughout a predetermined sliding operation time in every predetermined number of passed sheets set in advance, so that the surface state of the fixing rotator can be appropriately recovered against substantial damage occurring when a certain number of the unfavorable papers having severe burr in the edge portion of the recording material or the special papers is passed, or a certain number of papers is passed at a high speed. Therefore, occurrence of the gloss streak can be suppressed, and the abnormal image can be suppressed.

### (Other Configuration Examples)

Hereinafter, other embodiments of a fixing device according to the present disclosure will be described. Note that description about similar points to the above-described embodiment is appropriately omitted.

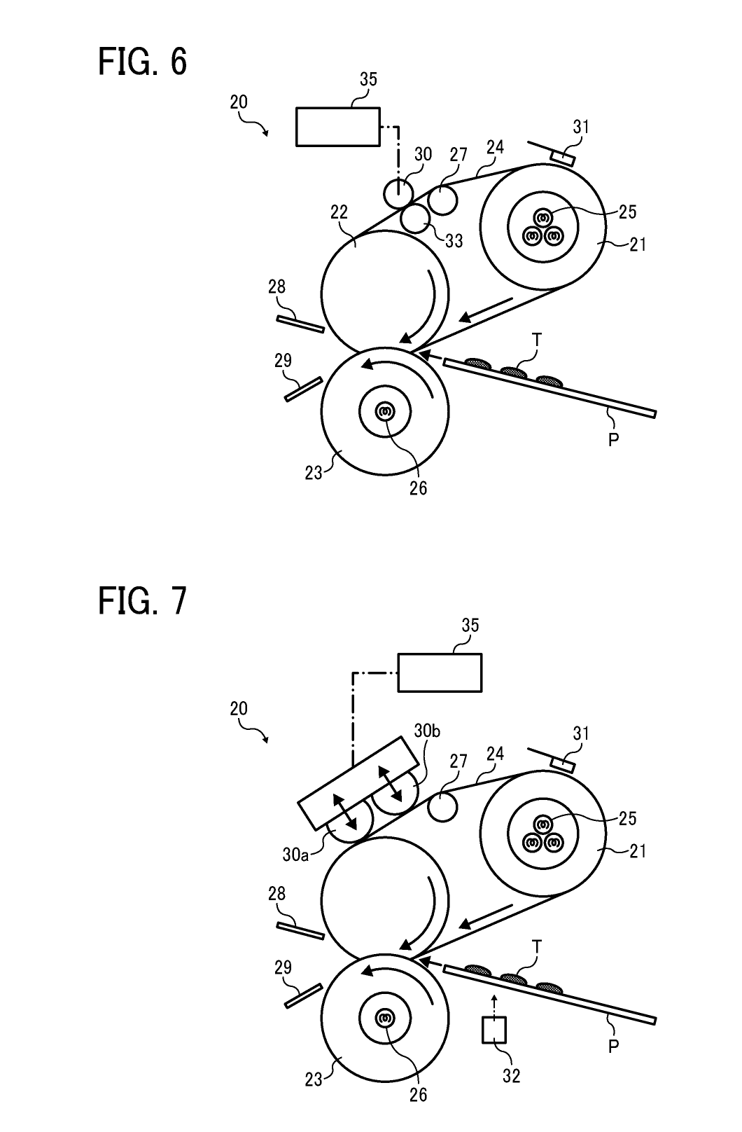

FIG. 6 illustrates another example of a fixing device 20, and a schematic cross-sectional view of a fixing roller 22 in the axial direction. In the example of FIG. 2, the slider is installed in a position opposing the fixing roller 22 across the fixing belt 24. However, the location of the slider 30 in the outer circumference of the fixing belt 24 is not limited to the example. For example, as illustrated in FIG. 6, it is favorable to provide a counter roller 33 in a position opposing a slider 30 across a fixing belt 24. Accordingly, favorable polishing performance can be obtained.

Further, FIG. 7 illustrates another example of a fixing device 20, and is a schematic cross-sectional view of a fixing roller 22 in an axial direction.

Here, a count of the number of passed sheets of the fixing device 20 may be based on a count of an image forming apparatus body 100 side. However, like the example of FIG. 7, a sheet passage sensor 32 may be disposed on a conveyance path of a recording medium P, and the number of passed sheets may be calculated according to an output that detects the recording medium P that enters to a nip. Note that the location of the sheet passage sensor 32 is not limited to the example of FIG. 7, and may be a position at a downstream side of the nip or a position on a conveyance route of the recording medium P.

Further, as illustrated in FIG. 7, it is favorable to provide two or more sliders 30a and 30b (two in FIG. 7) having different surface roughness as sliders 30. The sliders 30a and 30b are provided to press against the fixing belt 24 in a separable state, and a sliding operation is performed as a controller 35 selects one of the sliders 30. For example, the slider 30a can be used in a normal sliding operation, and the slider 30b can be used in an additional sliding operation.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A fixing device comprising:
a heater;
a fixing rotator to be heated by the heater;
a pressure rotator to press at least a portion of the fixing rotator and form a nip between the pressure rotator and the fixing rotator, the fixing rotator to fix an unfixed toner image on a recording material in the nip;
a slider to slide over a surface of the fixing rotator; and
a controller to cause the slider to perform a first sliding operation for a predetermined time after a predetermined condition is satisfied,
the controller to cause the slider to perform a second sliding operation for a time equal to or less than the predetermined time at earlier timing than when the predetermined condition is satisfied, in addition to the first sliding operation.

2. The fixing device according to claim 1,
wherein the controller causes the slider to perform the first sliding operation and the second sliding operation between jobs.

3. The fixing device according to claim 1,
wherein the predetermined condition to perform the first sliding operation is that a first predetermined number of sheets as the recording material passes the nip, and the earlier timing to perform the second sliding operation is after a second predetermined number of sheets less than the first predetermined number of sheets passes the nip.

4. The fixing device according to claim 3,
wherein the controller counts a number of passed sheets of each width of the recording material, and causes the slider to perform the first sliding operation and the second sliding operation based on the number of passed sheets of each width.

5. The fixing device according to claim 3,
wherein the controller counts a number of passed sheets by multiplexing a weighting coefficient according to a type of the recording material.

6. The fixing device according to claim 5,
wherein the weighting coefficient is arbitrarily settable.

7. The fixing device according to claim 1,
wherein the controller causes the slider to perform the second sliding operation twice or more at different timings and in different execution time periods.

8. The fixing device according to claim 1,
wherein a time period of at least one of the first sliding operation and the second sliding operation is arbitrarily settable.

9. An image forming apparatus comprising the fixing device according to claim 1.
